(19) United States
(12) Patent Application Publication
(10) Pub. No.: US 2007/0212151 A1
(43) Pub. Date: Sep. 13, 2007

(54) THERMAL TRANSFER PRINTER/LABELLER SPECIFICALLY DESIGNED FOR CASSETTES OR READY-TO-USE PACKAGES

(75) Inventors: Carlo Innocenti, Bologna (IT); Marzio Remo, Bologna (IT)

Correspondence Address: EGBERT LAW OFFICES, 412 MAIN STREET, 7TH FLOOR, HOUSTON, TX, 77002, US

(73) Assignee: ECOBAGS S.R.L., Bologna (IT)

(21) Appl. No.: 10/599,491

(22) PCT Filed: Apr. 13, 2005
(86) PCT No.: PCT/IT05/00212

§ 371 Date: Sep. 29, 2006

(30) Foreign Application Priority Data
Apr. 16, 2004 (IT) BO2004A000216

(51) Int. Cl. B41J 33/16

(52) U.S. Cl. 400/244

(57) ABSTRACT

The present invention relates to a thermal transfer printer/labeller supplied with a printing ribbon and receiving ribbon contained in cassettes or equivalent packages. The cassette, of a shape and size depending on the types of ribbon, protects the thermal transfer printing ribbon from contact with the operator, preventing the ribbon from being accidentally unwound during handling and conveyance and being easily inserted in the printer, using the fixed references.

### TECHNICAL FIELD

The present industrial invention relates to an automatic machine for printing holograms, marks, barcodes and variable data on labels and films. The printing operation is performed with thermal technology, using heat-sensitive paper or thermal transfer ribbons. The thermal transfer ribbon, e.g. “carbon ribbon”, and the labels or film medium are supplied to the machine in part or completely from special cassette-type containers or ready-to-use packages for which the printer is specifically designed.

### BACKGROUND ART

With specific reference to the thermal transfer printers available on the market today, we may note that in order to start the machine the operator must manually apply a spool of thermal transfer ribbon on the spindle of the apparatus, unwind a length of ribbon, routing it through diverter rollers and across the printhead, and connect and secure it to the take-up core. An equal series of steps is required for label spools, so that the two ribbons will be conveyed together, one overlying the other, between the printhead and drive roller.

### DISCLOSURE OF INVENTION

The primary aim of the present invention is to eliminate the obvious drawbacks associated with manual control of operations by devising a semiautomatic or completely automated loading system that can reduce downtimes and prevent damage or wastage, especially of the printing ribbon, by its nature very thin and susceptible to deterioration.

These and other aims are achieved by the device conceived according to this invention, which essentially consists of a polygon-shaped structure enclosing a cassette-type container of thermal transfer ribbon, a spool or cassette-type container of medium, or a single multiple cassette containing both, a thermal printhead, a series of driving devices, motorised and idle transmission elements for conveying the ribbons.

### BRIEF DESCRIPTION OF DRAWINGS

These and other features will now become more evident in relation to a simple embodiment of the invention, whose description serves purely illustrative purposes and in no way restricts the scope of this patent. Referring to the appended drawings where:

FIG. 1

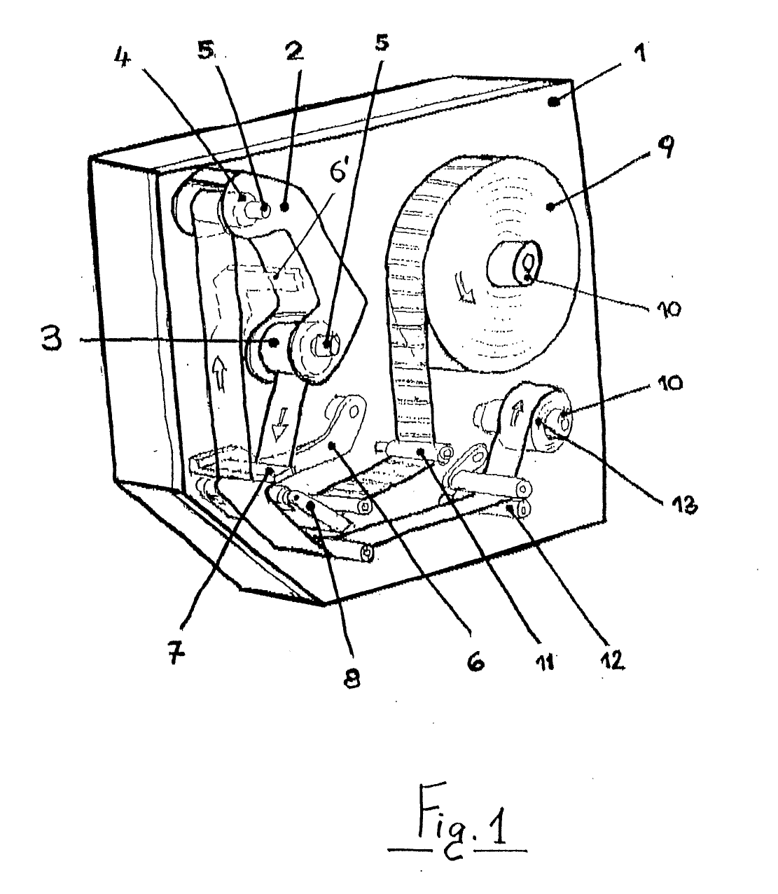

Provides a perspective view of the invention in the first version comprising only a thermal transfer ribbon contained in a cassette.

FIG. 2

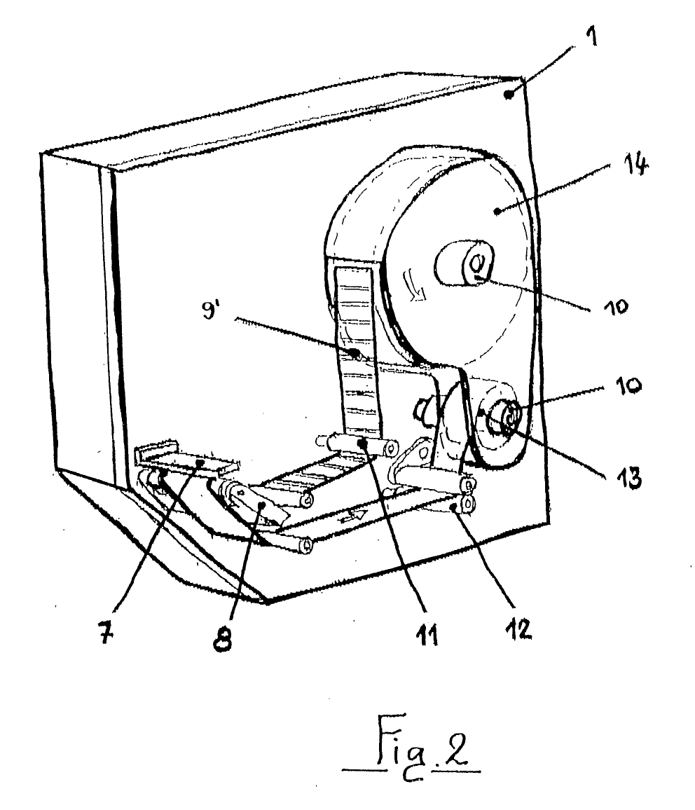

Provides a perspective view of the invention in the second version, wherein the cassette containing the heat-sensitive receiving paper is evident.

FIG. 3

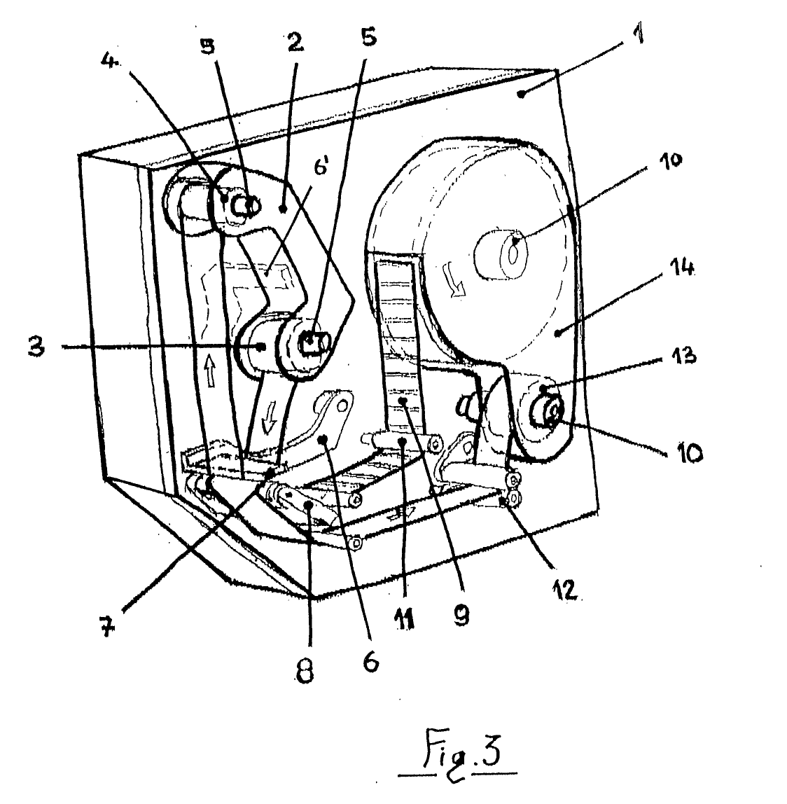

Provides a perspective view of the invention in the third version, called “double cassette”.

FIG. 4

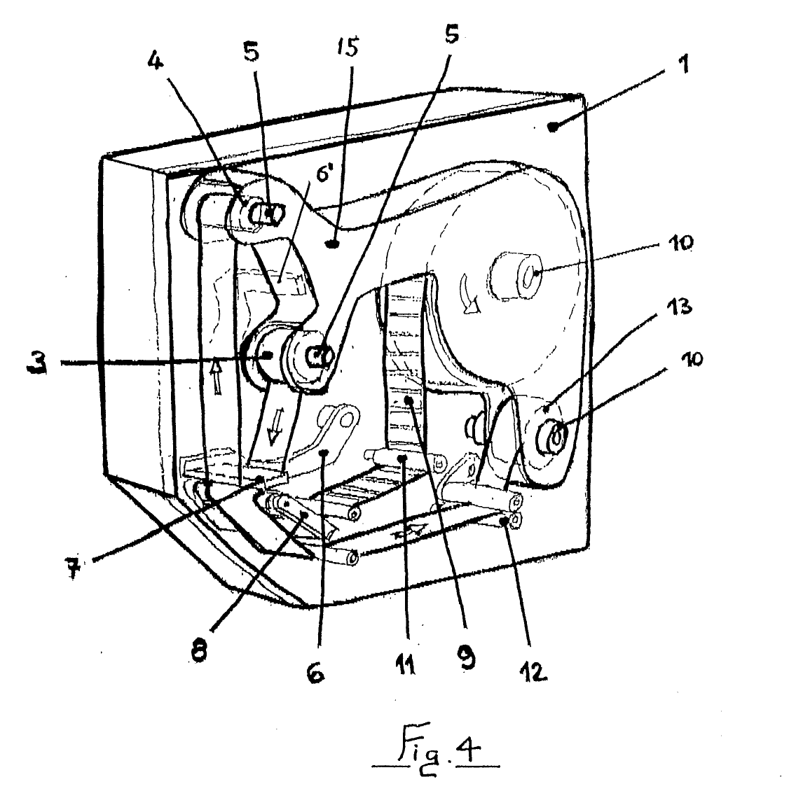

Provides a perspective view of the invention in the fourth version, called “multiple cassette”, the latter containing both the printing and receiving ribbons.

### BEST MODE FOR CARRYING OUT THE INVENTION

With reference to said figures, 1 indicates the structure of the apparatus called printer, 2 the cassette of a shape and size depending on the types of ribbon, which protects the thermal transfer printing ribbon 3 from contact with the operator, prevents it from being accidentally unwound during handling and conveyance and may be easily inserted in the printer using the fixed references of the latter as guides. 4 indicates the take-up core inside the cassette, which is necessary to rewind the used ribbon, 5 indicates the external driving device which rotates the take-up cores, 6 and 6′ in the rest position indicate a device specific to the printer which extracts the ribbon from the cassette and feeds it out, bringing it into contact with printhead 7 incorporated in the device itself, and the heat-sensitive paper serving as the printing medium 9, 9′, which is spooled on friction spindle 10, 11 indicates a series of guiding idle rollers and 8 a rubber-coated drive roller. The printing medium (9) is picked up by motorised rollers 12 and rewound around friction spindle 13.

14 indicates the cassette, of a shape and size depending on the types of ribbon, which contains a spool of the thermal printing medium (9′) and the take-up core (13), which will be engaged with the two driving devices (10) serving as guides.

15 indicates the multiple cassette-type container having a composite form, which contains the spool of ribbon (3) and take-up core (4) as well as the spool of the printing medium (9) and take-up core (13), which will be engaged with the two driving devices (5) and (10) serving as guides.

In practice the details of execution, dimensions, materials, shape and so forth of the invention may vary without departing from the scope of the present industrial patent. In fact, the invention thus conceived lends itself to numerous adaptations and embodiments, all of which falling within the framework of the inventive concept. Moreover, all of the elements may be replaced by other technically equivalent ones.

We claim:

1. A thermal transfer printer/labeller for cassettes or ready-to-use packages, said printer/labeller comprising:
an enclosing structure with motor drives, printing ribbons and receiving ribbons said motor drives being joined in a thermal printhead;
a printing cassette with a shape and size depending on a type of printing ribbon, said printing ribbon having a spool contained in said printing cassette, said printing cassette accommodating a take-up core and said spool of said printing ribbon, the core and spool having a central hole through which a driving device is inserted;
a first receiving cassette having an asymmetric conformation, said receiving ribbon having a spool contained in said receiving cassette, said receiving cassette containing said spool of ribbon medium and a take-up core, the core and spool having a central hole through which another driving device is inserted; and
a second receiving cassette having a composite form, distinct from said printing cassette and said first receiving cassette, said second receiving cassette having a front part containing a spool of said printing ribbon and said take-up core of said printing cassette, and a rear part holding said spool of said ribbon medium and said take-up core of said first receiving cassette, said front part and said rear part having a central hole to accommodate the driving devices of said printing cassette and said first receiving cassette; wherein the driving devices are externally motorized and guide the cassettes each driving device having a thermal printhead and a position adjusted via a device made integral with each driving device, each driving device having a series of idle rollers, a series of motorized rollers and a rubber-coated drive roller.

2. The printer/labeller according to claim 1, further comprising:
control devices locking said drive mechanisms and devices for rewinding and checking the ribbons for wear.

3. The printer/labeller according to claim 1, wherein said printing cassette, said first receiving cassette and said second receiving cassette are configured exclusively for ribbons contained in cassettes or equivalent quick-load packages.

4. The printer/labeller according to claim 1, wherein the cassettes are ready-to-use packages, each being comprised of a spool and take-up core rigidly connected by a rigid support.
